(19) United States
(12) Patent Application Publication
(10) Pub. No.: US 2019/0149362 A1
(43) Pub. Date: May 16, 2019

(54) HYBRID MIMO DETECTION OF OFDM SIGNALS

(71) Applicant: QUALCOMM Incorporated, San Diego, CA (US)

(72) Inventors: Louay Jalloul, San Jose, CA (US); Ahmad Abdulrahman Mohammed, San Jose, CA (US)

(21) Appl. No.: 15/812,526

(22) Filed: Nov. 14, 2017

(51) Int. Cl. H04L 25/02; H04B 7/0413; H04W 24/00; H04B 7/08; H04B 7/0456; H04L 27/26

(52) U.S. Cl. CPC H04L 25/0204; H04B 7/0413; H04W 24/00; H04W 84/12; H04B 7/0456; H04L 27/2647; H04L 25/0256; H04B 7/0868

(57) ABSTRACT

Systems and methods are disclosed that may detect data transmitted using MIMO communications. MIMO signals may be received via a wireless channel. Channel conditions may be estimated for the wireless channel based at least in part on the received MIMO signals. Each tone of the received MIMO signals may then be processed according to either a first receiver algorithm or a second receiver algorithm based at least in part on the estimated channel conditions, where the second receiver algorithm has a greater complexity and a greater accuracy than the first receiver algorithm.

### TECHNICAL FIELD

The example implementations relate generally to wireless communications systems, and specifically to methods of multiple-input multiple-output (MIMO) communications.

### DESCRIPTION OF THE RELATED TECHNOLOGY

A wireless local area network (WLAN) may be formed by one or more access points (APs) that provide a shared wireless communication medium for use by a number of client devices such as mobile stations (STAs). Multiple-input multiple-output (MIMO) signaling techniques allow an AP to transmit data to the STAs using multiple spatial streams, which may provide many advantages (such as higher throughput, extended coverage, increased diversity, and/or interference suppression) over conventional single antenna transmission techniques. For example, in a single-user MIMO (SU-MIMO) environment, the AP may use multiple antennas to transmit data to a single STA using multiple spatial streams, and the STA may use multiple antennas to receive the multiple spatial streams. The STA recovers the original data by decoding the received multiple spatial streams.

In MIMO communications, there are a number of differing types of detection algorithms, each having differing complexity, and accuracy, and requiring differing numbers of clock cycles to implement. Because both accuracy and speed are important considerations for detecting MIMO signals, it would be desirable to facilitate detection of MIMO signals in an accurate and time-efficient manner.

### SUMMARY

The systems, methods and devices of this disclosure each have several innovative aspects, no single one of which is solely responsible for the desirable attributes disclosed herein.

Aspects of the disclosure are directed to apparatuses and methods for hybrid detection of multiple-input multiple output (MIMO) signals. In one example, a method for hybrid detection of MIMO signals received via a wireless channel is disclosed. The method may include receiving the MIMO signals via the wireless channel, estimating channel conditions for the wireless channel based at least in part on the received MIMO signals, and processing each tone of the received MIMO signals according to at least one of a first receiver algorithm or a second receiver algorithm based at least in part on the estimated channel conditions, the second receiver algorithm having a greater complexity and accuracy than the first receiver algorithm.

In another example, a wireless receiver is disclosed. The wireless receiver may include one or more processors, one or more antennas, and a memory storing instructions that, when executed by the one or more processors, cause the wireless receiver to receive multiple-input multiple-output (MIMO) signals via a wireless channel, estimate channel conditions for the wireless channel based at least in part on the received MIMO signals, and process each tone of the received MIMO signals according to at least one of a first receiver algorithm or a second receiver algorithm based at least in part on the estimated channel conditions, the second receiver algorithm having a greater complexity and accuracy than the first receiver algorithm.

In another example, a non-transitory computer-readable storage medium is disclosed. The non-transitory computer-readable storage medium may store instructions that, when executed by one or more processors of a wireless receiver, cause the wireless receiver to receive multiple-input multiple-output (MIMO) signals via a wireless channel, estimate channel conditions for the wireless channel based at least in part on the received MIMO signals, and process each tone of the received MIMO signals according to at least one of a first receiver algorithm or a second receiver algorithm based at least in part on the estimated channel conditions, the second receiver algorithm having a greater complexity and accuracy than the first receiver algorithm.

In another example, a wireless receiver for hybrid detection of multiple-input multiple-output (MIMO) signals via a wireless channel is disclosed. The wireless receiver may include means for receiving the MIMO signals via the wireless channel, means for estimating channel conditions for the wireless channel based at least in part on the received MIMO signals, and means for processing each tone of the received MIMO signals according to at least one of a first receiver algorithm or a second receiver algorithm based at least in part on the estimated channel conditions, the second receiver algorithm having a greater complexity and accuracy than the first receiver algorithm.

### BRIEF DESCRIPTION OF THE DRAWINGS

FIG. 1 shows an example wireless system.

FIG. 2 shows a block diagram of a wireless station (STA).

FIG. 3 shows a block diagram of an access point (AP).

FIG. 4 shows an example MIMO receiver.

FIG. 5A depicts the transmission of data from a transmit (TX) device to a receive (RX) device using multi-user MIMO (MU-MIMO) communications.

FIG. 5B depicts the transmission of data from multiple TX devices to an RX device using multi-user MIMO (MU-MIMO) communications.

FIG. 6 depicts an example hybrid detector in a wireless system.

FIG. 7 is a flow chart showing an example operation for hybrid detection of MIMO signals.

FIG. 8 is another block diagram of several example aspects of apparatuses configured for hybrid detection of MIMO signals as taught herein.

Like reference numbers and designations in the various drawings indicate like elements.

### DETAILED DESCRIPTION

Apparatuses and methods are disclosed that may allow hybrid detection of multiple-input multiple-output (MIMO) signals received via a wireless channel. Channel conditions for the wireless channel may be estimated, and a tone metric may be determined for each tone of the received MIMO signals based on the estimated channel conditions. Each tone of the received MIMO signals may be processed according to a first receiver algorithm or a second receiver algorithm based on the determined tone metrics. In some implementations, the second receiver algorithm has a greater complexity and a greater accuracy than the first receiver algorithm. Thus, processing of the received MIMO signals using the second receiver algorithm may be concentrated on those tones where the increased accuracy provides the greatest benefit given the estimated channel conditions, while tones with lesser accuracy requirements may be processed using the more computationally- and time-efficient first receiver algorithm.

The example implementations are described below in the context of Wi-Fi enabled devices for simplicity only. It is to be understood that the example implementations are equally applicable to other wireless networks (such as 3GPP-LTE (long term evolution) standard, cellular networks, pico networks, femto networks, satellite networks), as well as for systems using signals of one or more wired standards or protocols (such as Ethernet and/or HomePlug/PLC standards). As used herein, the terms “wireless local area network (WLAN)” and “Wi-Fi” can include communications governed by the IEEE 802.11 standards, BLUETOOTH® (Bluetooth), HiperLAN (a set of wireless standards, comparable to the IEEE 802.11 standards, used primarily in Europe), and other technologies used in wireless communications such as LTE. In addition, although described herein in terms of exchanging data frames between wireless devices, the example implementations may be applied to the exchange of any data unit, packet, and/or frame between wireless devices. Thus, the term “frame” may include any frame, packet, or data unit such as, for example, protocol data units (PDUs), media access control (MAC) protocol data units (MPDUs), and physical (PHY) layer convergence procedure protocol data units (PPDUs). The term “A-MPDU” may refer to aggregated MPDUs.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Further, many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, the sequences of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present implementations. However, it will be apparent to one skilled in the art that these specific details may not be required to practice the present implementations. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. Implementations of this disclosure are not to be construed as limited to specific examples described herein but rather to include within their scope all implementations defined by the appended claims.

Wireless network technologies may include various types of wireless local area networks (WLANs). A WLAN may be used to interconnect wireless devices using well-known networking protocols. The implementations described herein may apply to various communication techniques, such as Wi-Fi or, more generally, any wireless protocol defined by the IEEE 802.11 standards.

In some aspects, wireless signals may be transmitted according to a high-efficiency wireless (HEW) protocol (such as defined by the IEEE 802.11ax specification) using orthogonal frequency-division multiplexing (OFDM), direct-sequence spread spectrum (DSSS) communications, a combination of OFDM and DSSS communications, or other schemes. Implementations of the HEW protocol may be used for Internet access, sensors, metering, smart grid networks, or other wireless applications. Wireless communications according to the HEW protocol may consume less power and/or may be more robust against signal interference (such as caused by objects such as humans) than wireless communications according to other wireless protocols.

In some implementations, a WLAN may include various component devices such as, for example, access points (“APs”) and wireless stations (“STAs”). In general, an AP serves as a hub or base station for the WLAN and a STA serves as a client of the WLAN. For example, a STA may be a laptop computer, a personal digital assistant (PDA), a mobile phone, etc. In an example, a STA connects to an AP via a wireless link (such as in accordance with the IEEE 802.11 standard) to obtain general connectivity to the Internet and/or other wide area networks. In some implementations a STA may also operate as a software-enable AP (“SoftAP”).

The techniques described herein may be used for various broadband wireless communication systems, including communication systems that are based on an orthogonal multiplexing scheme. Examples of such communication systems include Space Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may leverage the spatial locations of user terminals to simultaneously transmit data to multiple user terminals. A TDMA system may allow multiple user terminals to share the same frequency channel by dividing a communication interval into multiple time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 wireless protocols or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, OFDM symbols are signaled in the frequency domain and SC-FDMA symbols are signaled in the time domain. A SC-FDMA system may implement 3GPP-LTE (3rd Generation Partnership Project Long Term Evolution) or other standards.

The teachings herein may be incorporated into (such as implemented within or performed by) a variety of wired or wireless apparatuses (such as nodes). In some aspects, a wireless node implemented in accordance with the teachings herein may comprise an access point or an access terminal.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station “STA” may also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (such as a cellular phone or smartphone), a computer (such as a laptop), a portable communication device, a headset, a portable computing device (such as a personal data assistant), an entertainment device (such as a music or video device, or a satellite radio), a gaming device or system, a global positioning system device, or any other suitable device that is configured to communicate via a wireless medium.

As described above, algorithms for detection of MIMO signals may have differing complexity and accuracy, and thus there may be a trade-off between accurate detection on one hand, and simple or fast detection on the other. For example, linear detectors using a zero-forcing (ZF) or a minimum mean squared error (MMSE) algorithm may have a simpler design, but a lower accuracy as compared with near maximum likelihood (near ML) algorithms such as per-stream recursive demapping (PSRD) algorithms Further, because MIMO signals may be transmitted using a plurality of subcarriers, or tones—such as OFDM tones—which may have differing levels of channel correlation, there may be differing costs and benefits for processing a given tone with a fast but inaccurate algorithm as compared to a slower but more accurate algorithm.

Accordingly, the example implementations describe methods and systems for selectively processing each tone of received MIMO signals using either a first receiver algorithm or a second receiver algorithm, where the second receiver algorithm has a greater complexity and accuracy than the first receiver algorithm. Each tone may be processed using either the first receiver algorithm or the second receiver algorithm based on estimated channel conditions, such as, for example, a level of channel correlation between the tone and other tones of the received MIMO signals. These and other details of the example implementations, which provide one or more technical solutions to the aforementioned technical problems, are described in more detail below.

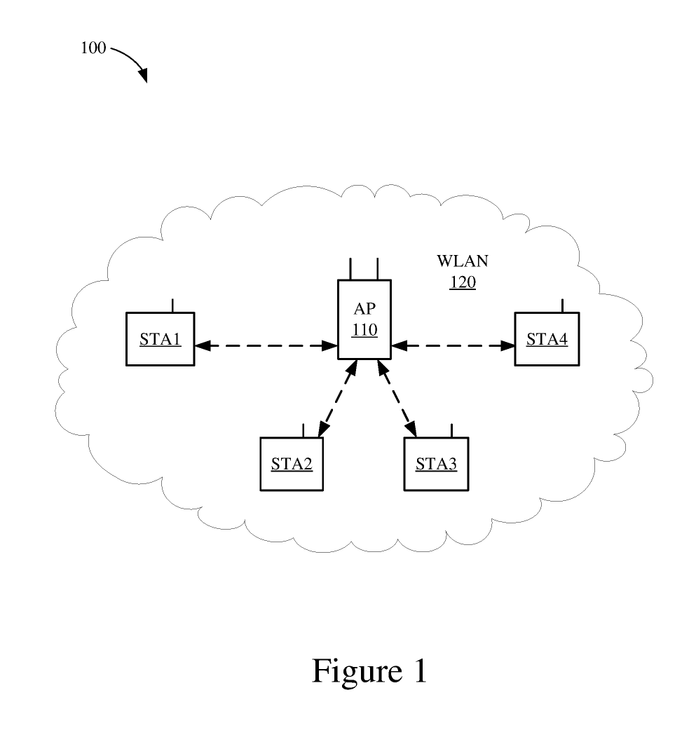

FIG. 1 is a block diagram of a wireless system 100. The system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of the stations STA1-STA4 is also assigned a unique MAC address. For some implementations, the wireless system 100 may correspond to a multiple-input multiple-output (MIMO) wireless network.

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each station STA may include one or more transceivers, one or more processing resources (such as processors and/or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing any of the operations described herein.

The AP 110 may be any suitable device that allows one or more wireless devices to connect to a network (such as a local area network (LAN), wide area network (WAN), metropolitan area network (MAN), and/or the Internet) via the AP 110 using Wi-Fi, Bluetooth, or any other suitable wireless communication standards. For at least one embodiment, the AP 110 may include one or more transceivers, a network interface, one or more processing resources, and one or more memory resources. The memory resources may include a non-transitory computer-readable medium (such as one or more nonvolatile memory elements, such as EPROM, EEPROM, Flash memory, a hard drive, etc.) that stores instructions for performing any of the operations described herein.

For the stations STA1-STA4 and/or the AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate in a 2.4 GHz frequency band and/or in a 5 GHz frequency band in accordance with the IEEE 802.11 specification. The cellular transceiver may communicate in various RF frequency bands in accordance with a 4G Long Term Evolution (LTE) protocol described by the 3rd Generation Partnership Project (3GPP) (such as between approximately 700 MHz and approximately 3.9 GHz) and/or in accordance with other cellular protocols (such as a Global System for Mobile (GSM) communications protocol). In other implementations, the transceivers included within the stations STA1-STA4 may be any technically feasible transceiver such as, for example, a ZigBee transceiver described by a specification from the ZigBee specification, a WiGig transceiver, and/or a HomePlug transceiver described a specification from the HomePlug Alliance.

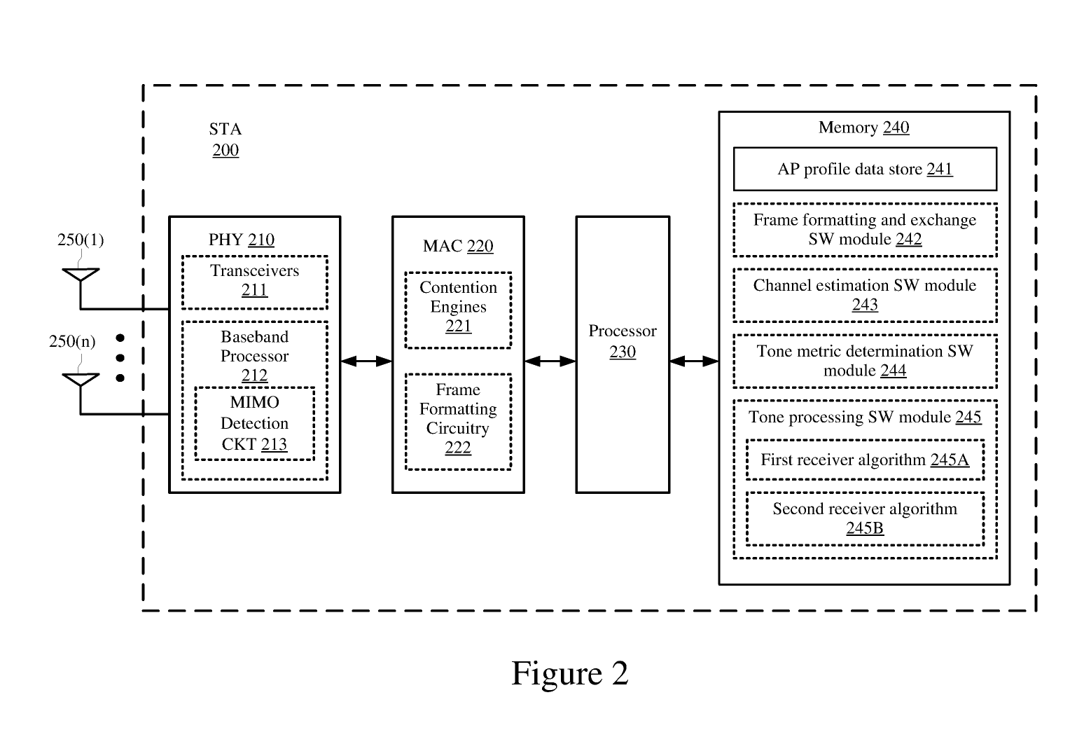

FIG. 2 shows a block diagram of an example STA 200. The STA 200 may be an example of each of the stations STA1-STA4 of FIG. 1. The STA 200 may include a PHY device 210 a MAC 220, a processor 230, a memory 240, and a number of antennas 250(1)-250(n). The PHY device 210 may include a number of transceivers 211 and a baseband processor 212. The transceivers 211 may be coupled to antennas 250(1)-250(n), either directly or through an antenna selection circuit (not shown for simplicity). The transceivers 211 may be used to transmit signals to and receive signals from the AP 110 and/or other STAs (see also FIG. 1), and may be used to scan the surrounding environment to detect and identify nearby access points and/or other STAs (such as within wireless range of the STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). In some implementations, the STA 200 may be configured for MIMO operations. The MIMO operations may include single-user MIMO (SU-MIMO) operations and multi-user MIMO (MU-MIMO) operations. For purposes of discussion herein, the MAC 220 is shown in FIG. 2 as being coupled between the PHY device 210 and the processor 230. For actual implementations, the PHY device 210, the MAC 220, the processor 230, and/or the memory 240 may be connected together using one or more buses (not shown for simplicity).

The baseband processor 212 may be used to process signals received from the processor 230 and/or the memory 240 and to forward the processed signals to the transceivers 211 for transmission via one or more of antennas 250(1)-250(n), and may be used to process signals received from one or more of antennas 250(1)-250(n) via the transceivers 211 and to forward the processed signals to the processor 230 and/or the memory 240. The baseband processor may also include a MIMO detection circuit 213. The MIMO detection circuit 213 may be used to detect a number of spatial streams transmitted according to one or more MIMO communication modes, for example, as described in more detail below.

The MAC 220 may include a number of contention engines 221 and frame formatting circuitry 222. The contention engines 221 may contend for access to one or more shared wireless mediums, and may also store packets for transmission over the one or more shared wireless mediums. The STA 200 may include one or more contention engines 221 for each of a plurality of different access categories. For other implementations, the contention engines 221 may be separate from the MAC 220. For still other implementations, the contention engines 221 may be implemented as one or more software modules (such as stored in the memory 240 or stored in memory provided within the MAC 220) containing instructions that, when executed by the processor 230, perform the functions of contention engines 221.

The frame formatting circuitry 222 may be used to create and/or format frames received from the processor 230 and/or the memory 240 (such as by adding MAC headers to PDUs provided by the processor 230), and may be used to re-format frames received from the PHY device 210 (such as by stripping MAC headers from frames received from the PHY device 210).

The memory 240 may include an AP profile data store 241 that stores profile information for a plurality of APs. The profile information for a particular AP may include information such as, for example, the AP's SSID, MAC address, channel information, received signal strength indication (RSSI) values, goodput values, channel state information (CSI), supported data rates, MIMO capabilities, connection history with the AP, a trustworthiness value of the AP (such as indicating a level of confidence about the AP's location, etc.), and any other suitable information pertaining to or describing the operation of the AP.

The memory 240 may also include a non-transitory computer-readable medium (such as one or more nonvolatile memory elements, such as EPROM, EEPROM, Flash memory, a hard drive, and so on) that may store at least the following software (SW) modules:
a frame formatting and exchange software module 242 to facilitate the creation and exchange of any suitable frames (such as data frames, action frames, and management frames) between STA 200 and other wireless devices;
a channel estimation software module 243 to estimate channel conditions, such as channel matrix estimations, and to decompose estimated channel matrices using, for example, QR matrix decomposition;
a tone metric determination software module 244 to determine tone metrics for tones of received MIMO signals; and
a tone processing software module 245 to process tones of received MIMO signals according to at least one of a first receiver algorithm 245A or a second receiver algorithm 245B based on the determined tone metrics.
   Each software module includes instructions that, when executed by processor 230, cause STA 200 to perform the corresponding functions.

The processor 230 may execute the frame formatting and exchange software module 242 to facilitate the creation and exchange of any suitable frames (such as data frames, action frames, and management frames) between STA 200 and other wireless devices. The processor 230 may also execute the channel estimation software module 243 to estimate channel conditions, such as channel matrix estimations, and to decompose estimated channel matrices using, for example, QR matrix decomposition. The processor 230 may also execute the tone metric determination software module 244 to determine tone metrics for tones of received MIMO signals. The processor 230 may also execute the tone processing software module 245 to process tones of received MIMO signals according to at least one of a first receiver algorithm 245A or a second receiver algorithm 245B based on the determined tone metrics.

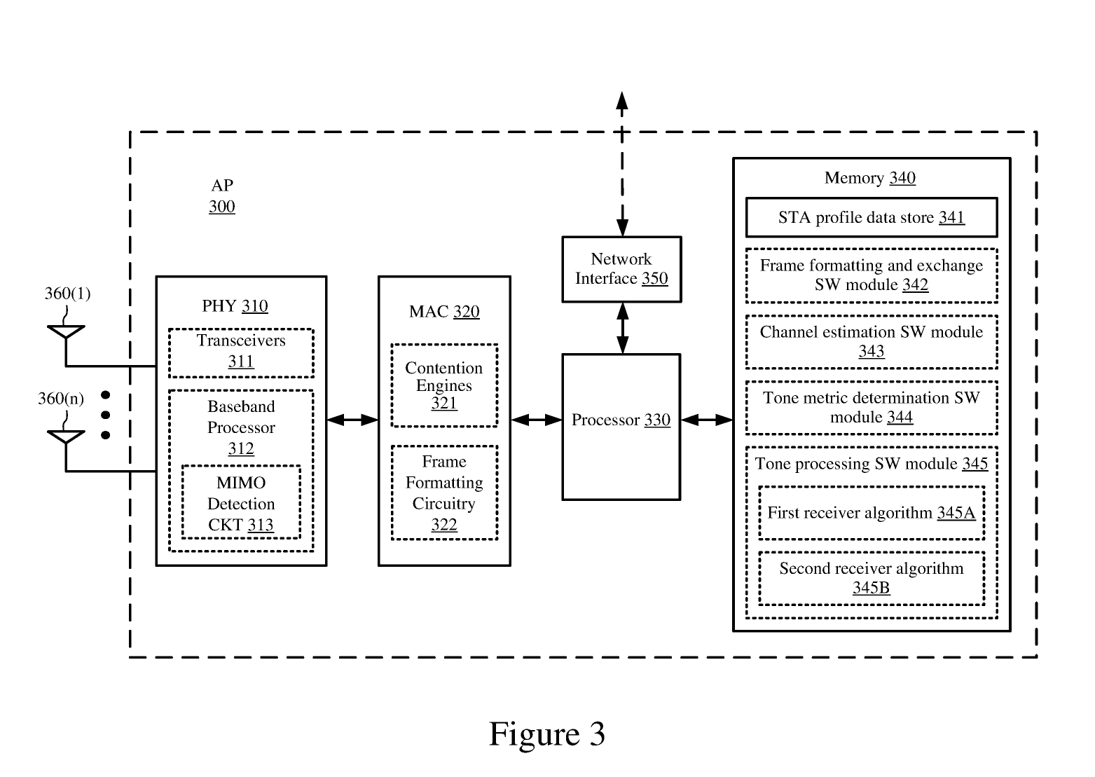

FIG. 3 shows a block diagram of an example AP 300. The AP 300 may be an implementation of the AP 110 of FIG. 1. The AP 300 may include a PHY device 310, a MAC 320, a processor 330, a memory 340, a network interface 350, and a number of antennas 360(1)-360(n). The PHY device 310 may include a number of transceivers 311 and a baseband processor 312. The transceivers 311 may be coupled to antennas 360(1)-360(n), either directly or through an antenna selection circuit (not shown for simplicity). The transceivers 311 may be used to communicate wirelessly with one or more STAs, with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). In some implementations, the AP 300 may be configured for MIMO operations including, for example, SU-MIMO operations and MU-MIMO operations. For purposes of discussion herein, the MAC 320 is shown in FIG. 3 as being coupled between the PHY device 310 and the processor 330. For actual implementations, the PHY device 310, the MAC 320, the processor 330, the memory 340, and/or the network interface 350 may be connected together using one or more buses (not shown for simplicity).

The baseband processor 312 may be used to process signals received from the processor 330 and/or the memory 340 and to forward the processed signals to the transceivers 311 for transmission via one or more of antennas 360(1)-360(n), and may be used to process signals received from one or more of antennas 360(1)-360(n) via the transceivers 311 and to forward the processed signals to the processor 330 and/or the memory 340. The baseband processor 312 may also include a MIMO detection circuit 313. The MIMO detection circuit 313 may be used to detect and decode a number of spatial streams transmitted according to one or more MIMO communication modes, for example, as described in more detail below.

The network interface 350 may be used to communicate with a WLAN server (not shown for simplicity) either directly or via one or more intervening networks and to transmit signals.

The MAC 320 may include a number of contention engines 321 and frame formatting circuitry 322. The contention engines 321 may contend for access to the shared wireless medium, and may also store packets for transmission over the shared wireless medium. For some implementations, the AP 300 may include one or more contention engines 321 for each of a plurality of different access categories. For other implementations, the contention engines 321 may be separate from the MAC 320. For still other implementations, the contention engines 321 may be implemented as one or more software modules (such as stored in the memory 340 or within memory provided within the MAC 320) containing instructions that, when executed by the processor 330, perform the functions of the contention engines 321.

The frame formatting circuitry 322 may be used to create and/or format frames received from the processor 330 and/or the memory 340 (such as by adding MAC headers to PDUs provided by the processor 330), and may be used to re-format frames received from the PHY device 310 (such as by stripping MAC headers from frames received from the PHY device 310).

The memory 340 may include a STA profile data store 341 that stores profile information for a plurality of STAs. The profile information for a particular STA may include information such as, for example, its MAC address, supported data rates, MIMO capabilities, connection history with the AP 300, and any other suitable information pertaining to or describing the operation of the STA.

The memory 340 may also include a non-transitory computer-readable medium (such as one or more nonvolatile memory elements, such as EPROM, EEPROM, Flash memory, a hard drive, and so on) that may store at least the following software (SW) modules:
a frame formatting and exchange software module 342 to facilitate the creation and exchange of any suitable frames (such as data frames, action frames, and management frames) between the AP 300 and other wireless devices;
a channel estimation software module 343 to estimate channel conditions, such as channel matrix estimations, and to decompose estimated channel matrices using, for example, QR matrix decomposition;
a tone metric determination software module 344 to determine tone metrics for tones of received MIMO signals; and
a tone processing software module 345 to process tones of received MIMO signals according to at least one of a first receiver algorithm 345A or a second receiver algorithm 345B based on determined tone metrics.
   Each software module includes instructions that, when executed by the processor 330, cause the AP 300 to perform the corresponding functions.

The processor 330 may execute the frame formatting and exchange software module 342 to facilitate the creation and exchange of any suitable frames (such as data frames, action frames, and management frames) between the AP 300 and other wireless devices. The processor 330 may also execute the channel estimation software module 343 to estimate channel conditions, such as channel matrix estimations, and to decompose estimated channel matrices using, for example, QR matrix decomposition. The processor 330 may also execute the tone metric determination software module 344 to determine tone metrics for tones of received MIMO signals. The processor 330 may also execute the tone processing software module 345 to process tones of received MIMO signals according to at least one of a first receiver algorithm 345A or a second receiver algorithm 345B based on determined tone metrics.

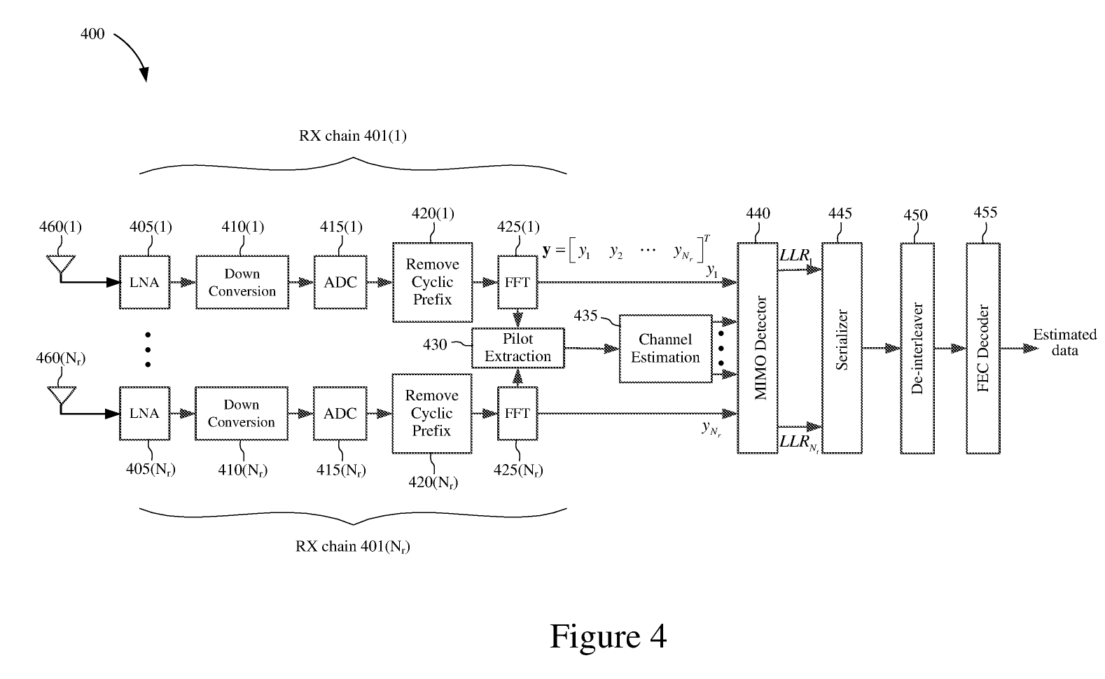

FIG. 4 shows an example MIMO receiver 400. The MIMO receiver 400 may be implemented within transceivers 211 of STA 200 (see FIG. 2) and/or within transceivers 311 of AP 300 (see FIG. 3). As shown in FIG. 4, MIMO receiver 400 may include a number Nᵣ of receive antennas 460(1)-460(Nᵣ), which for some implementations may be antennas 260(1)-260(n) of STA 200 and/or antennas 360(1)-360(n) of AP 300. The antennas 460(1)-460(Nᵣ) may receive data as a number Nₜ of spatial streams, which may be processed to determine (i) a receive data stream y and (ii) a channel estimation matrix H. The MIMO receiver 400 may include a plurality of receive (RX) chains 401(1)-401(Nᵣ), each coupled to a corresponding one of antennas 460(1)-460(Nᵣ). For example, after a first signal is received by antenna 460(1), the first signal may be processed by a first receive chain 401(1) that may include a low noise amplifier (LNA) 405(1), a down conversion circuit 410(1), an analog-to-digital converter (ADC) 415(1), a cyclic prefix remover 420(1), fast Fourier transform (FFT) logic 425(1), pilot extraction logic 430, and channel estimation logic 435. The down conversion circuit 410(1) may generate in-phase and quadrature signals (not shown in FIG. 4 for simplicity), for example, using one or more local oscillator signals (not shown in FIG. 4 for simplicity). The ADC 415(1) may be a pair of ADCs to process the in-phase and quadrature signals generated by the down conversion circuit 410(1). For the example of FIG. 4, signals received by antennas 460(2)-460(Nᵣ) may be processed in a similar manner by RX chains 401(2)-401(Nᵣ), respectively.

In the case of single user MIMO (SU-MIMO), a receive data vector y and a channel estimation matrix H may be provided to the MIMO detector 440 to produce log likelihood ratios (LLRs) LLR₁-LLR_{Nt}. The LLRs may be serialized by a serializer 445 to generate a serial data stream. For some implementations, the serializer 445 may be implemented as a multiplexer, that selects each of the LLR₁-LLR_{Nt} signals in succession, to generate the serial data stream. The serial data stream may be provided to de-interleaver 450, which de-interleaves the serial data stream. The resulting de-interleaved serial data stream may be provided to a forward error correction (FEC) decoder 455. The FEC decoder 455 may generate an estimate of the received data. In the case of multi-user MIMO (MU-MIMO), the LLR streams from all the users may not be multiplexed together for decoding—instead, LLR streams belonging to given transmitters may be decoded separately.

For other implementations, the order of the serializer 445 and the de-interleaver 450 may be reversed, for example, so that the de-interleaver 450 de-interleaves the LLR₁-LLR_{Nt} signals, and the serializer 445 converts the de-interleaved LLR signals into a serial data stream.

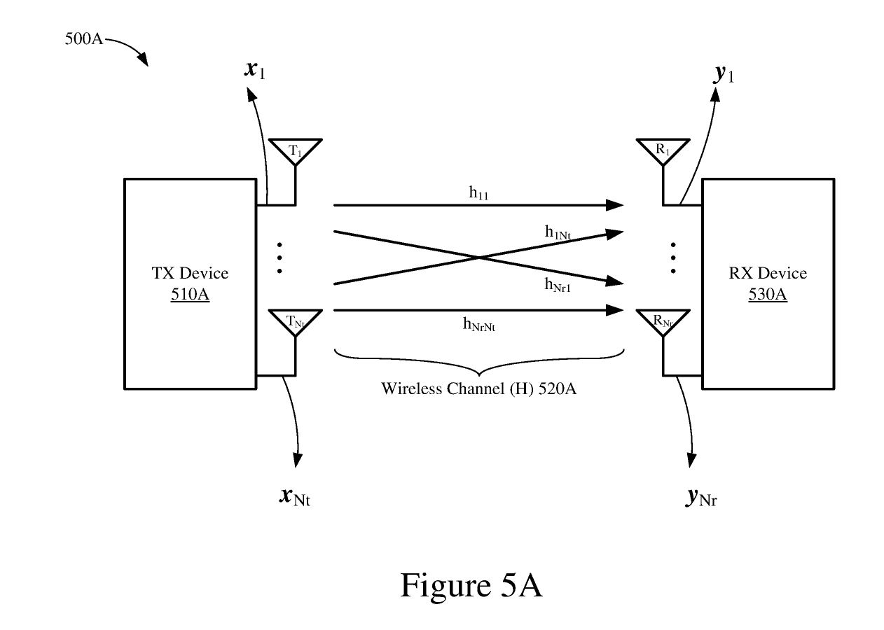

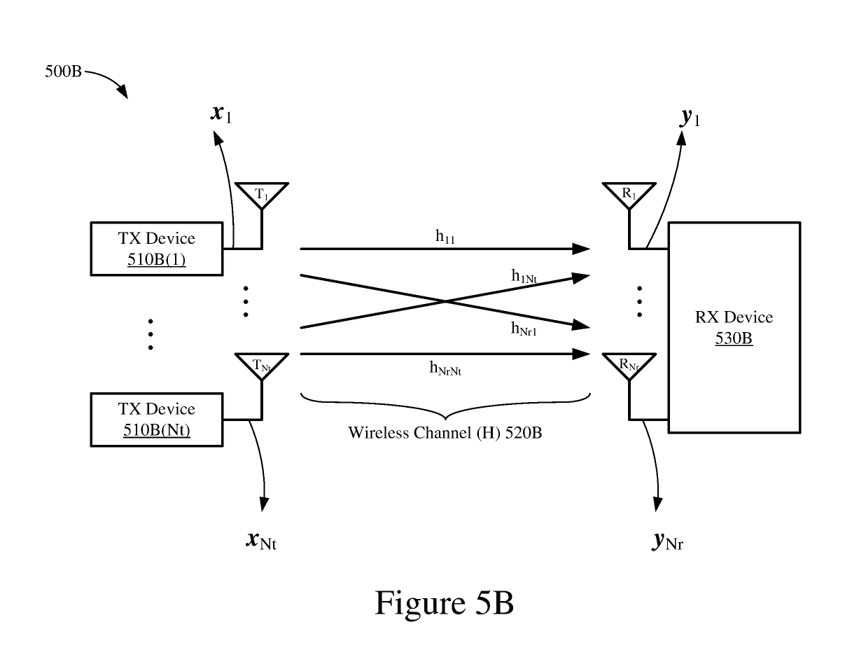

FIG. 5A shows an example communications system 500A. The communications system 500A includes a TX device 510A, an RX device 530A, and a wireless channel 520A. For purposes of discussion herein, the TX device 510A may be any one of the stations STA1-STA4 of FIG. 1, and the RX device 530A may be the AP 110 of FIG. 1. For another embodiment, the TX device 510A may be a first STA, and the RX device 530A may be a second STA. For yet another embodiment, the TX device 510A and the RX device 530A may both be APs. Although not shown in FIG. 5 for simplicity, the RX device 530A may include one or more MIMO receivers, such as, for example, the MIMO receiver 400 of FIG. 4.

As depicted in FIG. 5A, the TX device 510A transmits signals x onto wireless channel 520A, and the RX device 530A receives signals y via the wireless channel 520A. In some implementations, the TX device 510A and the RX device 530A may each be configured for MIMO communications. For example, the TX device 510A may transmit multiple streams of data, concurrently, to the RX device 530A. MIMO communications between a single TX device and a single RX device (such as depicted in FIG. 5A) may be conducted using SU-MIMO signaling techniques. For example, the TX device 510A may include a number Nₜ of transmit antennas T₁-T_{Nt}, and the RX device 530A may include a number Nᵣ of receive antennas R₁-R_{Nr}. The TX device 510A may encode data to be transmitted to the RX device 530A as an NᵣₓNₜ MIMO stream, and then transmit the NᵣₓNₜ MIMO stream to the RX device 530A using N spatial streams (where N is at most the lesser of Nᵣ and N₁). The RX device 530A may receive the N spatial streams, and may decode data contained in the N spatial streams to recover the original data. Because the data was transmitted to the RX device 530A as MIMO-encoded data, the RX device 530A uses data received by each of its antennas to recover the original data.

Through spatial multiplexing, the TX device 510A may transmit a first set of data (such as x₁={x₁₁, x₁₂, x₁₃, . . . , x_{1M}}) on a first spatial stream (SS₁) via first transmit antenna T₁ while concurrently transmitting (N-1) other sets of data (such as x₂={x₂₁, x₂₂, x₂₃, . . . , x_{2M}} . . . x_{N}={x_{N1}, x_{N2}, x_{N3}, . . . , x_{NM}}) on a number N-1 of other spatial streams (SS₂-SS_{N}) via transmit antennas T₂-T_{Nt}, respectively.

Each of the receive antennas R₁-R_{Nr} of the RX device 530A may receive a combination of data transmitted by the antennas T₁-T_{Nt} of the TX device 510A. For example, the first receive antenna R₁ may receive data from each of spatial streams SS₁-SS_{N}, the second receive antenna R2 may receive data from each of spatial streams SS₁-SS_{N}, and so on. Channel conditions of the wireless channel 520A and/or spatial orientation of the receive antennas R₁-R_{Nr} may cause differences in the data patterns received by each of the receive antennas R₁-R_{Nr}. Thus, the data received by first receive antenna R₁ (denoted as y₁={y₁₁, y₁₂, y₁₃ . . . y_{1M}}) may differ from the data received by the N^{th} receive antenna R_{Nr} (denoted as y_{N}={y_{N1}, y_{N2}, y_{N3}, . . . , y_{NM}}). In some example implementations, a received data vector y may be determined from the signals received at antennas R₁-R_{Nr} using MIMO receiver 400 of FIG. 4.

The wireless channel 520A may be modeled as an Nᵣ×Nₜ channel matrix H:

$$H = [ \begin{matrix}{h}_{11} & ⋯ & {h}_{1 Nt} \\ ⋮ & ⋱ & ⋮ \\ {h}_{Nr 1} & ⋯ & {h}_{NrNt}\end{matrix} ]$$

The received data vector y may be expressed as a function of the transmitted data (x):

y=Hx+u (1)

where y=[y₁ . . . y_{N}_{ᵣ}]^{T}, x=[x₁, . . . x_{N}_{ₜ}], and u=[u₁ . . . u_{N}_{ᵣ}]^{T} is the noise component due to thermal noise or other interference (typically modeled as a zero mean complex Gaussian circularly symmetric noise vector with E[uu*]=σ²I). The representative channel matrix H for the wireless channel 520A may be determined by the RX device 530A, for example, using channel estimation logic 435 of the MIMO receiver 400 (such as using pilot tones or based on a transmitted preamble).

For the example of FIG. 5A, the TX device 510A may use MIMO encoding techniques to encode data to be transmitted to the RX device 530A as N MIMO streams (MU₁-MU_{N}). The first signal is received by antenna R₁, and the k^{th} signal is received by antenna Rₖ (k ranging from 1 to Nᵣ). The N MIMO streams MU₁-MU_{N} may be concurrently transmitted from the TX device 510A to the RX device 530A using spatial streams SS₁-SS_{N}. The RX device 530A may receive and independently decode the N MIMO streams MU₁-MU_{N}.

FIG. 5B shows another example communications system 500B. The communications system 500B includes a plurality of TX devices 510B(1)-510B(Nₜ), a RX device 530B, and a wireless channel 520B. For purposes of discussion herein, each of the TX devices 510B(1)-510B(Nₜ) may be one of the stations STA1-STA4 of FIG. 1, and the RX device 530B may be the AP 110 of FIG. 1.

As depicted in FIG. 5B, the TX devices 510B(1)-510B(Nₜ) transmit signals onto wireless channel 520B, and the RX device 530B receives the signals via the wireless channel 520B. In some implementations, the TX devices 510B(1)-510B(Nₜ) and the RX device 530B may each be configured for MIMO communications. For example, the TX devices 510B(1)-510B(Nₜ) may each transmit one or more streams of data, concurrently, to the RX device 530B. MIMO communications between multiple TX devices and a single RX device (such as depicted in FIG. 5B) are typically conducted using MU-MIMO signaling techniques. For example, if the TX devices 510B(1)-510B(Nₜ) each have 1 antenna and the RX device 530B includes Nᵣ antennas, then the TX devices 510B(1)-510B(Nₜ) may each encode data to be transmitted to the RX device 530B into a corresponding MIMO stream, and then transmit the corresponding MIMO stream to RX device 530B as a single spatial stream. The RX device 530B may receive the N spatial streams, and may decode data contained in the N spatial streams to recover the original data transmitted from each of TX devices 510B(1)-510B(Nₜ). Because the data was transmitted to the RX device 530B as MU-MIMO encoded data, the RX device 530B uses data received by each of its antennas R₁-R_{Nr} to recover the original data (such as data transmitted from TX device 510A).

More specifically, the first TX device 510B(1) may transmit a first set of data (such as x₁={x₁₁, x₁₂, x₁₃, . . . , x_{1M}}) as a first spatial stream (SS₁) via a first transmit antenna Ti. Each of the other TX devices 510B(2)-510B(N) may transmit a different set of data via respective spatial streams, concurrently with the first TX device 510B(1). For example, each k^{th} TX device 510B(k) may transmit a set of data (such as xₖ={xₖ₁, xₖ₂, xₖ₃, . . . , x_{kM}}) on a k^{th} spatial stream SSₖ via a corresponding transmit antenna Tₖ.

Similarly to FIG. 5SA, each of the receive antennas R₁-R_{Nr} of the RX device 530B may receive a combination of data transmitted by the antennas T₁-T_{Nt} of the TX devices 510B(1)-510B(Nt), respectively. The received data vector y and the channel estimate matrix H may also be determined in a manner similar to that described above with respect to FIG. 5A.

As discussed above, MIMO signal detection algorithms may have differing performance and complexity. These algorithms may be generally classified into three categories. First there may be linear detectors, which may use algorithms such as zero-forcing (ZF) or minimum mean-squared error (MMSE) algorithms Second, there may be tree-search based methods using algorithms such as sphere decoding, using K-best, multiple tree search, single tree-search, and so on. Finally, there may be list decision feedback equalizer (DFE) based algorithms, which may include ZF-DFE based per-stream recursive demapping (PSRD) or MMSE-DFE based PSRD.

While linear algorithms such as MMSE have the lowest complexity among these three categories, they also tend to have the lowest accuracy, falling far below that of an optimal maximum likelihood (ML) detector, such as a max-log-MAP (MLM) detector. However, ML algorithms have prohibitively large computational complexity for most applications, having exponential complexity such as O{2Σₙ₊₁^{N}^{ₜ}Mₙ}where Nₜ is the number of transmitted spatial streams, and Mₙ is the constellation size of the n^{th} spatial stream. Tree-search based methods may have non-fixed processing times, and may be difficult to implement for large constellation sizes. However, such methods may achieve near ML performance. PSRD based methods may also achieve near ML performance Further, PSRD methods may have complexity proportional to a product of the number of spatial streams and the constellation size (or the subset of a constellation)—in other words Σₙ₌₁^{N}^{ₜ}Mₙ. Thus, while tree-search based methods may also achieve near ML performance, PSRD based methods may be preferable for single and multi-user MIMO detectors. Hereinafter, the term “near ML” may be used to refer to such PSRD based algorithms

Performance of a MIMO detector may also depend on an eigenvalue spread of the channel matrix. This eigenvalue spread may be considered as a function of the correlations between columns of the channel matrix. Channel matrices whose columns have low correlation will have less performance loss for a linear receiver relative to a PSRD-based receiver as compared to channel matrices having highly correlated columns. For example, an orthogonality factor OF for a channel matrix H may be defined as

$$OF ( H ) = \frac{\sqrt{det ( {H}^{*} H )}}{{\prod }_{n = 1}^{{N}_{t}} ‖ {h}_{n} ‖}$$

where hₙ is the n^{th} column of H. OF(H)=0 indicates that the columns of H being linearly dependent, while OF(H)=1 indicates that the columns are orthogonal. Further, if OF(H)=1, then H*H is diagonal, and the linear detection algorithm solution may be equivalent to the ML solution.

While near ML algorithms such as PSRD may result in accurate detection, the complexity and required clock cycles for such algorithms may be unacceptably high. For example, the complexity and time required to process such algorithms may be too large for a receiver to meet required turnaround times (for example a required ACK/NACK turnaround time). This problem may be even more pronounced in uplink (UL) OFDMA applications, where each user may be assigned multiple spatial streams.

The example implementations recognize that the above-described orthogonality factor suggest that not all OFDM tones (or subcarriers) are equally correlated. Thus, according to the example implementations, the tones of the received MIMO signals may be selectively processed using one of multiple possible algorithms More particularly, tones whose channel have relatively high correlation may be processed using a complex but accurate algorithm, such as a near ML detection algorithm. Tones whose channel have relatively low correlation may be processed using a faster but less accurate algorithm such as MMSE. For example, a MIMO detector may receive MIMO signals, and determine which tones of the MIMO signals to process using a linear detection algorithm, and which tones to process using a near ML algorithm.

For example, after channel estimation, the columns of the channel matrix H may be permuted for each of the spatial streams, such that

PₘH=QₘRₘ

where Pₘ is a permutation matrix which moves the m^{th} column of H to be the final column position, where Qₘ is unitary, and where Rₘ is upper-triangular with real-positive diagonal entries. Q* may be applied to a received vector of OFDM symbols, and the result input to the MIMO demapper together with the R matrix to produce the LLRs for a given spatial stream.

According to the example implementations, rather than calculating the orthogonality factor OF (H) as described above, a similar metric may be used which is more closely related to a near ML detection algorithm. This may allow for the determination of which algorithm should be used to process each tone to be completed with minimal additional computations or complexity. For example, a tone metric may be determined indicating a degree of correlation for a wireless channel over which a given tone was sent. This tone metric may be referred to as η(f). For some implementations, η(f) may be selected to have values similar to OF(H), such that η(f) may range between zero and one, η(f) near unity indicates a low degree of correlation, and η(f) near zero indicates a high degree of correlation. Accordingly, tones with η(f)>T may be processed using a first receiver algorithm, which may be a linear algorithm such as MMSE (where T represents a correlation threshold). This may be appropriate given that the channels for such tones have a relatively low degree of correlation. The remaining tones—having relatively high channel correlation—may be processed using a second receiver algorithm, such as a near ML algorithm. Processing such tones having relatively low η(f) may be appropriate because near ML algorithms may be more accurate, and may be beneficial given the channel correlation indicated by η(f).

Note that for some other implementations, η(f) may vary between different minimum and maximum values, and lower values of η(f) may indicate lower rather than higher degrees of correlation.

For some examples, η(f) may be based on the entries of the upper triangular R matrix. For one example, note that R(1:n−1, n) indicates the degree to which the n^{th} column of H depends on the previous columns 1 to n-1. Thus, the value of R(n, n) indicates the degree to which the n^{th} column of H is independent of the previous columns 1 to n-1. Accordingly, one example η(f) may be based on a ratio of the diagonal entries of R to all of the entries of R. For example, such a metric may be given by

$$η ( f ) = \frac{{\sum }_{l = 1}^{{N}_{t}} {\sum }_{n = 1}^{{N}_{t}} {f}_{q} ( {R}_{k , l} ( n , n ) )}{{\sum }_{n = 1}^{{N}_{t}} {\sum }_{m = n}^{{N}_{t}} {f}_{q} ( {R}_{k , l} ( n , m ) )}$$

where η(f) represent the metric for the k^{th} tone, Nₜ is the number of transmitted spatial streams, R_{k,l} is the R matrix of the k^{th} tone and the l^{th} spatial stream, and where f_{q}(x)=|Re(x)|^{q}+|Im(x)|^{q}, where q is a positive integer, such as one or two.

According to other implementations, η(f) may be defined as other similar metrics, such as

$$η ( f ) = \frac{{\sum }_{l = 1}^{{N}_{t}} {min}_{n} ( {f}_{q} ( {R}_{k , l} ( n , n ) ) )}{{\sum }_{l = 1}^{{N}_{t}} {max}_{n} ( {f}_{q} ( {R}_{k , l} ( n , n ) ) )}$$

$$or$$

$$η ( f ) = \frac{{\sum }_{l = 1}^{{N}_{t}} ( {f}_{q} ( {R}_{k , l} ( {N}_{t} , {N}_{t} ) ) )}{{\sum }_{n = 1}^{{N}_{t}} {\sum }_{n = 1}^{{N}_{t}} ( {f}_{q} ( {R}_{k , l} ( n , {N}_{t} ) ) )} .$$

According to some example implementations, the threshold T may be set such that a selected proportion λ, λ ∈(0,1) of the tones are detected using the second algorithm (such as a near ML algorithm), and a remaining proportion (1−λ) of the tones are processed using the first algorithm (such as a linear algorithm including, for example, a ZF algorithm or an MMSE algorithm). For some implementations, the selected proportion may be a constant proportion, while for some other implementations the selected proportion may be adapted based on channel conditions. For example, as channel conditions improve, the selected proportion may be reduced, such that a greater proportion of the tones are processed using the first algorithm. Further, if channel conditions worsen, the first algorithm's performance may decrease, and the selected proportion may be increased, for example, such that more tones are processed using the second algorithm.

Further, the selected proportion may be determined to ensure that the corresponding tones are detected within a predetermined time period. For example, the IEEE 802.11 protocols require acknowledgements to be received within a predetermined time period—called an ACK timeout. If no acknowledgement is received before the ACK timeout, a transmitting device may assume that a transmitted packet has been lost, and may retransmit the packet. Thus, in some example implementations, the selected proportion may be determined to ensure that the corresponding tones (or MIMO signals) are detected within a predetermined time period, for example, to enable their acknowledgment before an ACK timeout period has elapsed.

Thus, the example hybrid detection methods allow for more accurate detection for tones having high channel correlation as compared to detectors using the first algorithm. Further, because detecting MIMO signals using the first algorithm is less computationally complex and less time-consuming than detection using the second algorithm, the hybrid detection process according to the example implementations is faster than detection using only the second algorithm. For example, assume a detection process according to the second algorithm—for example, a near ML algorithm—may complete in α clock cycles, while a detection process according to the first algorithm—for example, an MMSE algorithm—may complete in β clock cycles, where α>β. As discussed above, because the example tone metrics are computed using quantities already used for the first algorithm, the tone metric determination does not significantly increase a complexity of a hybrid detection method according to the example implementations. Thus, hybrid near ML/MMSE detection may consume τ cycles, where τ=K(αλ+β(1−λ)), where K is the total number of tones in a packet, and λ is the proportion of tones processed using the near ML algorithm. Clearly τ≤αK, where αK is the number of clock cycles consumed using near ML detection. Further, because τ≤αK, a clock frequency for a hybrid detector according to the example implementations may be reduced as compared to a detector employing only the second algorithm, such as a near ML algorithm. More particularly, if f_{clk} represents a clock frequency for a near ML detector, then a hybrid detector according to some example implementations may be clocked at a reduced frequency given by

$${f}_{clk , hybrid} = {f}_{clk} \cdot \frac{αγ + β ( 1 - γ )}{α} \leq {f}_{clk} .$$

Thus, the clock frequency may be reduced, and additionally the power consumption may be reduced for a hybrid detector according to the example implementations as compared with a detector according to the second detector algorithm.

In some implementations, the second algorithm may be adapted based at least in part on the tone metrics. More particularly, a constellation search size of the second algorithm may be adapted based on the tone metrics. For one example, a given tone may have an initial tone metric indicating that the tone should be processed according to the second algorithm. Over time, the initial tone metric may change, indicating a reduced channel correlation—for example, according to the above-described tone metrics, the tone metric may increase, indicating the reduced channel correlation. If a difference between the changed tone metric and the initial tone metric exceeds an algorithm adaption threshold, then the constellation search size for the second algorithm may be reduced, improving the processing time for the second algorithm. Further, if the changed tone metric exceeds the initial tone metric by more than an algorithm changing threshold—the algorithm changing threshold exceeding the algorithm adaption threshold—then for subsequent detections, the given tone may be processed according to the first algorithm rather than the second algorithm.

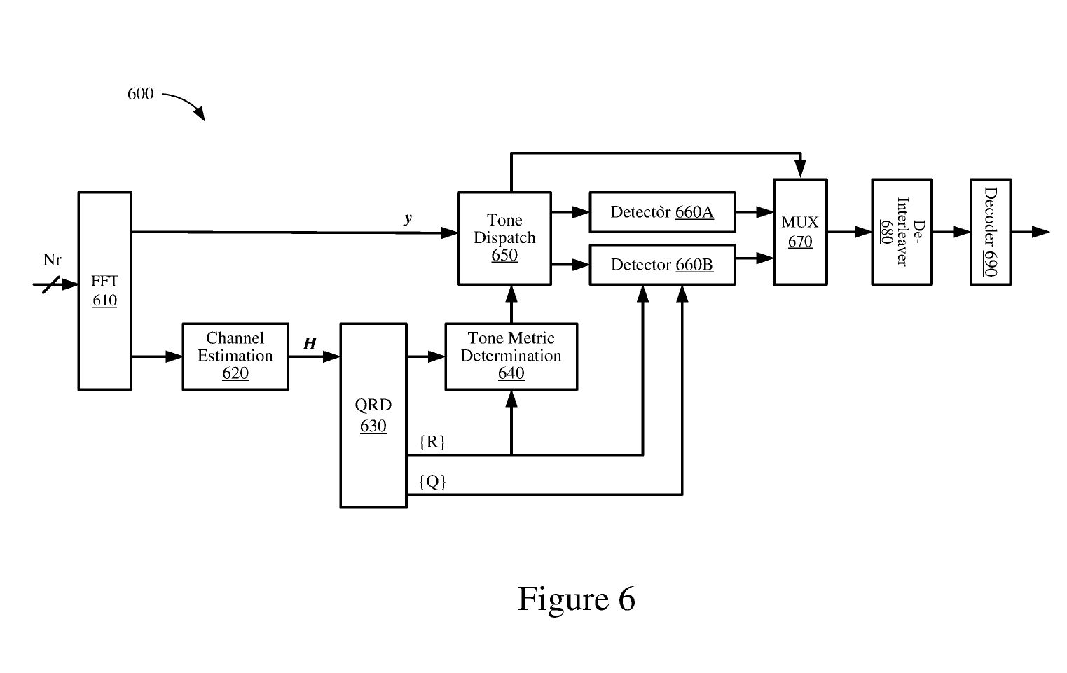

FIG. 6 shows a block diagram of a hybrid detector 600 according to some example implementations. With respect to FIG. 6, a number Nᵣ of MIMO signals may be received at FFT 610. The FFT 610 may be one example of the FFT 425(1)-425(Nᵣ) of FIG. 4. Further, the FFT 610 may output frequency-domain representations of the MIMO signals, which may be passed to channel estimation logic 620, and to tone dispatch logic 650. The channel estimation logic 620 may be one example of the pilot extraction logic 430 and the channel estimation logic 435 of FIG. 4. The channel estimation logic 620 may estimate a channel matrix H based on the frequency-domain representations of the received MIMO signals, and may pass the channel estimation to Q-R Decomposition (QRD) logic 630. The QRD logic 630, the tone metric determination logic 640, the tone dispatch logic 650, and the detectors 660A and 660B may be an example of the MIMO detector 440 of FIG. 4, according to the example implementations. The QRD logic 630 may perform a Q-R decomposition of the estimated channel matrix for each tone and spatial stream of the received MIMO signals. The set of determined R matrices may be passed to the tone metric determination logic 640 and to the detector 660B, while the set of Q matrices may be passed only to the detector 660B. The tone metric determination logic 640 may determine a tone metric for each tone of the received MIMO signals. As discussed above, this tone metric may be a metric η(f) which is determined based on the R matrices. The determined tone metrics may be sent to the tone dispatch logic 650. The tone dispatch logic 650 may selectively pass received tones of the frequency domain signals to either the detector 660A or the detector 660B based on the determined tone metrics, as discussed above. The tone dispatch logic 650 may also send an indication to the multiplexor (MUX) 670 indicating which tones were passed to the detector 660A and which were passed to the detector 660B. The detector 660A may be a detector employing a first receiver algorithm, which may be a linear algorithm such as ZF or MMSE. The detector 660B may employ a second receiver algorithm, such as a near ML algorithm (for example, PSRD). The respective outputs of the detectors 660A and 660B may be multiplexed together using the MUX 670 based on the indications received from the tone dispatch logic 650 to generate a single serialized data stream of the detector outputs. The de-interleaver 680 may then de-interleave the serial data stream and send it to the decoder 690 for decoding into estimated data bits. The de-interleaver 680 and the decoder 690 may be one example of the de-interleaver 450 and the FEC decoder 455 of FIG. 4.

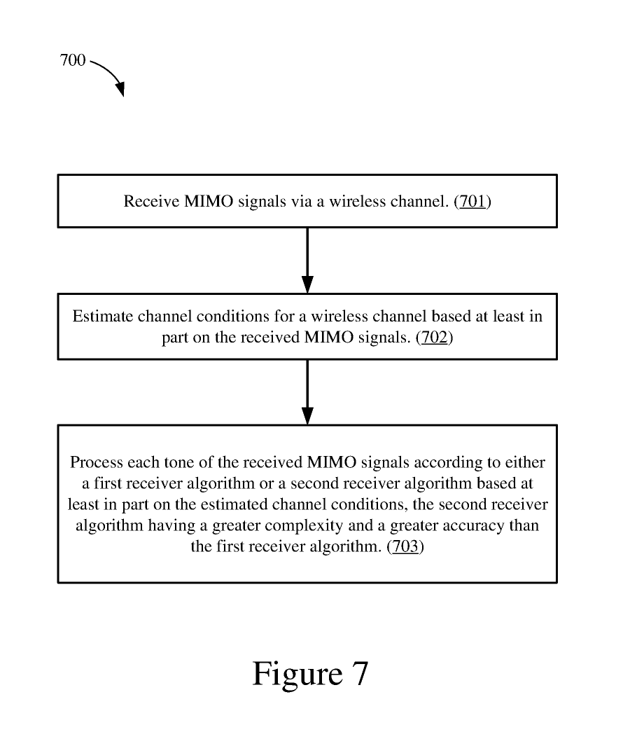

FIG. 7 shows a flowchart depicting an example operation 700 for hybrid detection of multiple-input multiple-output (MIMO) signals received via a wireless channel, according to the example implementations. The operation 700 may be performed by any suitable wireless receiver, such as the AP 110 or the stations STA1-STA4 of FIG. 1, the STA 200 of FIG. 2, the AP 300 of FIG. 3, the MIMO receiver 400 of FIG. 4, the RX device 530A of FIG. 5A, the RX device 530B of FIG. 5B, or the hybrid detector 600 of FIG. 6.

With respect to FIG. 7, a wireless receiver may receive MIMO signals via a wireless channel (701). For example, the wireless receiver may receive the MIMO signals using antennas 250(1)-250(n), the PHY 210, the MAC 220, the processor 230, or by executing the frame formatting and exchange SW module 242 of the STA 200 of FIG. 1, or using antennas 360(1)-360(n), the PHY 310, the MAC 320, the processor 330, or by executing the frame formatting and exchange SW module 342 of the AP 300 of FIG. 3.

Channel conditions may be estimated for the wireless channel based at least in part on the received MIMO signals (702). For example, the wireless receiver may estimate the channel conditions by executing the channel estimation SW module 243 of the STA 200 of FIG. 2, by executing the channel estimation SW module 343 of the AP 300 of FIG. 3, using the channel estimation 435 of the receiver 400, or using the channel estimation 620 of the hybrid detector 600 of FIG. 6.

Each tone of the received MIMO signals may then be processed according to either a first receiver algorithm or a second receiver algorithm based at least in part on the estimated channel conditions, where the second receiver algorithm has a greater complexity and a greater accuracy than the first receiver algorithm (703). For example, the tones of the received MIMO signals may be processed using the MIMO detection CKT 213, or by executing the tone metric determination SW module 244 or the tone processing SW module 245 of the STA 200 of FIG. 2, using the MIMO detection CKT 313, or by executing the tone processing SW module 345 of the AP 300 of FIG. 3, or using the QRC 630, the tone metric determination logic 640, the tone dispatch logic 650, the detectors 660A and 660B, and the MUX 670 of the hybrid detector 600 of FIG. 6.

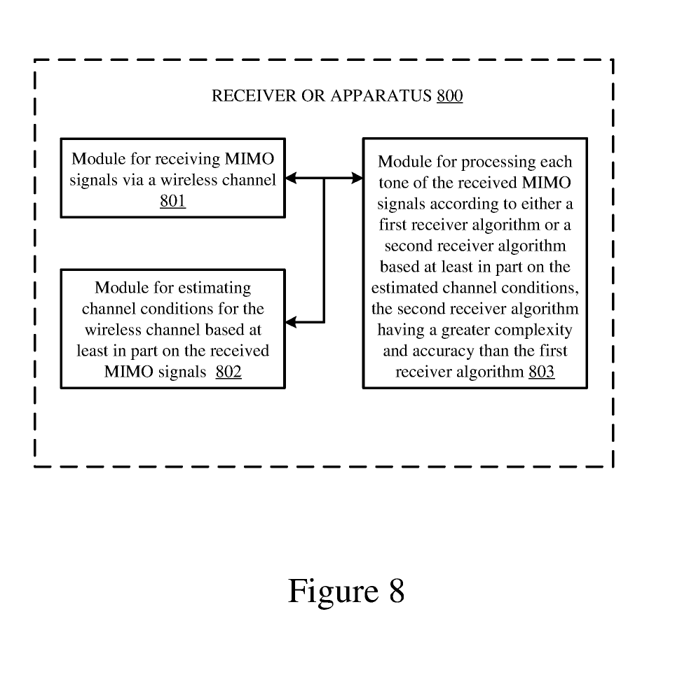

FIG. 8 shows an example MIMO receiver or apparatus 800 represented as a series of interrelated functional modules. A module 801 for receiving MIMO signals via a wireless channel may correspond at least in some aspects to, for example, a processor as discussed herein (such as the processor 230 of FIG. 2 and/or the processor 330 of FIG. 3) and/or a number of antennas as discussed herein (such as antennas 250(1)-250(n) of FIG. 2, antennas 360(1)-360(n) of FIG. 3, and/or antennas 460(1)-460(n) of FIG. 4), and/or a PHY as discussed herein (such as the PHY 210 of FIG. 2, the PHY 310 of FIG. 3, and/or the RX chains 401(1)-401(Nᵣ) of FIG. 4). A module 802 for estimating channel conditions for the wireless channel based at least in part on the received MIMO signals may correspond at least in some aspects to, for example, a processor as discussed herein (such as the processor 230 of FIG. 2 and/or the processor 330 of FIG. 3) and/or a number of antennas as discussed herein (such as antennas 250(1)-250(n) of FIG. 2, antennas 360(1)-360(n) of FIG. 3, and/or antennas 460(1)-460(n) of FIG. 4), and/or a channel estimation SW module (such as the channel estimation SW module 243 of FIG. 2, the channel estimation SW module 343 of FIG. 3, the channel estimation 435 of FIG. 4, or the channel estimation 620 of FIG. 6). A module 803 for processing each tone of the received MIMO signals according to either a first receiver algorithm or a second receiver algorithm based at least in part on the determined tone metrics, the second receiver algorithm having a greater complexity and accuracy than the first receiver algorithm may correspond at least in some aspects to, for example, a processor as discussed herein (such as the processor 230 of FIG. 2 and/or the processor 330 of FIG. 3) and/or or a tone metric determination SW module (such as the tone determination SW module 244 of FIG. 2, the tone determination SW module 344 of FIG. 3, or the tone metric determination logic 640 of FIG. 6), and/or a tone processing SW module (such as the tone processing SW module 245 of FIG. 2, the tone processing SW module 345 of FIG. 3, or the tone dispatch logic 650 and the detectors 660A and 660B).

The functionality of the modules of FIG. 8 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (such as an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (such as of an integrated circuit and/or of a set of software modules) may provide at least a portion of the functionality for more than one module.

In addition, the components and functions represented by FIG. 8, as well as other components and functions described herein, may be implemented using any suitable means. Such means also may be implemented, at least in part, using corresponding structure as taught herein. For example, the components described above in conjunction with the “module for” components of FIG. 8 also may correspond to similarly designated “means for” functionality. Thus, in some aspects, one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, one aspect of the disclosure can include a non-transitory computer readable media embodying a method for time and frequency synchronization in non-geosynchronous satellite communication systems. The term “non-transitory” does not exclude any physical storage medium or memory and particularly does not exclude dynamic memory (such as conventional random access memory (RAM)) but rather excludes only the interpretation that the medium can be construed as a transitory propagating signal.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

Wwhat is claimed is:

1. A method comprising:
receiving multiple-input multiple-output MIMO signals via a wireless channel, each MIMO signal including a number of tones;
estimating channel conditions for the wireless channel based at least in part on the received MIMO signals; and
processing each tone of the received MIMO signals using either a first receiver algorithm or a second receiver algorithm based at least in part on the estimated channel conditions, the second receiver algorithm having a greater complexity and accuracy than the first receiver algorithm.

2. The method of claim 1, wherein the first receiver algorithm is a minimum mean-squared error (MMSE) algorithm and the second receiver algorithm is a near maximum likelihood (near ML) algorithm.

3. The method of claim 1, further comprising:
reducing a detector clock frequency based at least in part on a proportion of the received tones processed by the first receiver algorithm.

4. The method of claim 1, further comprising:
determining a tone metric for each tone of the received MIMO signals, wherein the processing of each tone of the received MIMO signals using either the first receiver algorithm or the second receiver algorithm based at least in part on the estimated channel conditions includes processing each tone of the received MIMO signals using either the first receiver algorithm or the second receiver algorithm based on the corresponding tone metric.

5. The method of claim 4, wherein the processing of each tone of the received MIMO signals based on the corresponding tone metric comprises:
processing a first proportion of the tones according to the first receiver algorithm, the first proportion corresponding to a threshold value of the tone metric; and
processing a remaining proportion of the tones according to the second receiver algorithm.

6. The method of claim 5, wherein the first proportion and the remaining proportion are adapted based on the estimated channel conditions.

7. The method of claim 5, wherein the first proportion and the remaining proportion are selected to ensure the MIMO signals are detected within a predetermined time period.

8. The method of claim 4, wherein each determined tone metric corresponds to a level of channel correlation for a corresponding tone.

9. The method of claim 4, wherein estimating channel conditions comprises:
determining a channel matrix for the wireless channel, wherein the tone metric is based on a QR decomposition of the determined channel matrix.

10. The method of claim 4, further comprising:
adaptively reducing a constellation search size of the second receiver algorithm based at least in part on the tone metric.

11. A wireless receiver, comprising:
one or more processors;
one or more antennas; and
a memory storing one or more programs comprising instructions that, when executed by the one or more processors, cause the wireless receiver to:
receive multiple-input multiple-output (MIMO) signals via a wireless channel using the one or more antennas, each MIMO signal including a number of tones;
estimate channel conditions for the wireless channel based at least in part on the received MIMO signals; and
processing each tone of the received MIMO signals according to either a first receiver algorithm or a second receiver algorithm based at least in part on the estimated channel conditions, the second receiver algorithm having a greater complexity and accuracy than the first receiver algorithm.

12. The wireless receiver of claim 11, wherein the first receiver algorithm is a minimum mean-squared error (MMSE) algorithm and the second receiver algorithm is a near maximum likelihood (near ML algorithm.

13. The wireless receiver of claim 11, wherein execution of the instructions further causes the wireless receiver to reduce a detector clock frequency based at least in part on a proportion of the received tones processed by the first receiver algorithm.

14. The wireless receiver of claim 11, wherein execution of the instructions further causes the wireless receiver to:
determine a tone metric for each tone of the received MIMO signals, wherein the processing of each tone of the received MIMO signals using either the first receiver algorithm or the second receiver algorithm based at least in part on the estimated channel conditions includes processing each tone of the received MIMO signals using either the first receiver algorithm or the second receiver algorithm based on the corresponding tone metric.

15. The wireless receiver of claim 14, wherein execution of the instructions to process each tone of the received MIMO signals based on the corresponding tone metric causes the wireless receiver to:
process a first proportion of the tones according to the first receiver algorithm, the first proportion corresponding to a threshold value of the tone metric; and
process a remaining proportion of the tones according to the second receiver algorithm.

16. The wireless receiver of claim 15, wherein the first proportion and the remaining proportion are adapted based on the estimated channel conditions.

17. The wireless receiver of claim 15 wherein the first proportion and the remaining proportion are selected to ensure the MIMO signals are detected within a predetermined time period.

18. The wireless receiver of claim 14, wherein each determined tone metric corresponds to a level of correlation for a corresponding tone.

19. The wireless receiver of claim 14, wherein execution of the instructions to estimate channel conditions further causes the wireless receiver to determine a channel matrix for the wireless channel, wherein the tone metric is based on a QR decomposition of the determined channel matrix.

20. The wireless receiver of claim 14, wherein execution of the instructions further causes the wireless receiver to adaptively reduce a constellation search size of the second receiver algorithm based at least in part on the tone metric.

21. A non-transitory computer-readable storage medium storing one or more programs comprising instructions that when executed by one or more processors of a wireless receiver, cause the wireless receiver to:
receive multiple-input multiple-output (MIMO) signals via a wireless channel using one or more antennas, each MIMO signal including a number of tones;
estimate channel conditions for the wireless channel based at least in part on the received MIMO signals; and
processing each tone of the received MIMO signals according to either a first receiver algorithm or a second receiver algorithm based at least in part on the estimated channel conditions, the second receiver algorithm having a greater complexity and accuracy than the first receiver algorithm.

22. The non-transitory computer-readable storage medium of claim 21, wherein the first receiver algorithm is a minimum mean-squared error (MMSE) algorithm and the second receiver algorithm is a near maximum likelihood (near ML) algorithm.

23. The non-transitory computer-readable storage medium of claim 21, wherein execution of the instructions further causes the wireless receiver to reduce a detector clock frequency based at least in part on a proportion of the received tones processed by the first receiver algorithm.

24. The non-transitory computer-readable storage medium of claim 21, wherein execution of the instructions further causes the wireless receiver to:
determine a tone metric for each tone of the received MIMO signals, wherein the processing of each tone of the received MIMO signals using either the first receiver algorithm or the second receiver algorithm based at least in part on the estimated channel conditions includes processing each tone of the received MIMO signals using either the first receiver algorithm or the second receiver algorithm based on the corresponding tone metric.

25. The non-transitory computer-readable storage medium of claim 24, wherein execution of the instructions to process each tone of the received MIMO signals based on the corresponding tone metric further causes the wireless receiver to:
process a first proportion of the tones according to the first receiver algorithm, the first proportion corresponding to a threshold value of the tone metric; and
process a remaining proportion of the tones according to the second receiver algorithm.

26. The non-transitory computer-readable storage medium of claim 24, wherein the first proportion and the remaining proportion are adapted based on the estimated channel conditions.

27. The non-transitory computer-readable storage medium of claim 24, wherein each determined tone metric corresponds to a level of channel correlation for a corresponding tone.

28. The non-transitory computer-readable storage medium of claim 24, wherein execution of the instructions further causes the wireless receiver to adaptively reduce a constellation search size of the second receiver algorithm based at least in part on the tone metrics.

29. A wireless receiver for hybrid detection of multiple-input multiple-output (MIMO) signals received via a wireless channel, comprising:
means for receiving the MIMO signals via the wireless channel, each MIMO signal including a number of tones;
means for estimating channel conditions for the wireless channel based at least in part on the received MIMO signals; and
means for processing each tone of the received MIMO signals according to either a first receiver algorithm or a second receiver algorithm based at least in part on the estimated channel conditions, the second receiver algorithm having a greater complexity and accuracy than the first receiver algorithm.

30. The wireless receiver of claim 29, further comprising:
means for determining a tone metric for each tone of the received MIMO signals, wherein the processing of each tone of the received MIMO signals using either the first receiver algorithm or the second receiver algorithm based at least in part on the estimated channel conditions includes processing each tone of the received MIMO signals using either the first receiver algorithm or the second receiver algorithm based on the corresponding tone metric.
